(19) United States
(12) Patent Application Publication
(10) Pub. No.: US 2012/0312891 A1
(43) Pub. Date: Dec. 13, 2012

(54) Concrete Spraying Method Using Heat Recovery

(76) Inventors: Dieter Mai, Glattbrugg (CH); Christian Krebs, Wilen (CH); Andre Walliser, Hegenheim (FR)

(21) Appl. No.: 13/574,075

(22) PCT Filed: Jan. 14, 2011
(86) PCT No.: PCT/EP11/50473

§ 371 Date: Aug. 24, 2012

(30) Foreign Application Priority Data
Jan. 21, 2010 (EP) 10151300.0

(51) Int. Cl. B05B 7/16; C04B 14/06

(52) U.S. Cl. 239/8; 106/638

(57) ABSTRACT

Method for the application of sprayed concrete by using a 3-way control nozzle as mixing device for ready mix concrete, liquid admixtures and compressed air, characterized in, that the liquid admixtures and/or the conveying air are heated prior and/or during to the spraying.

The present invention relates to a method for the application of sprayed concrete, a method for the accelerated hardening of sprayed concrete and a hardened sprayed concrete produced by the method.

### BACKGROUND OF THE INVENTION

The application of cementitious compositions such as concrete to a substrate by spraying from a nozzle is a well-established technology, and is widely used in such applications as the lining of tunnels. There is a considerable variety of specific admixtures known to, for example, sulfonate melamine formaldehyde condensate, sulfonate naphthalene formaldehyde condensate, or acrylic polymer families, and used by the art for the workability of the sprayed concrete.

It is well known that heat can influence the hydration of cement systems in a positive way. Not only the hardening period (early strength period) but also final strength, quality of hardened concrete and last but not least durability are well influenced by increased hydration temperatures. Therefore, the spraying of concrete at the higher temperature conditions might be a valuable addition to the process.

The object of the invention is to provide a method for the application of sprayed concrete by using a 3-way control nozzle as mixing device for ready mix concrete, liquid admixtures and compressed air, characterized in, that the liquid admixtures are heated prior to the spraying.

Surprisingly it has been found that elevated temperatures, in the majority cause better influences to the hydration of cementitious, such as sprayed concrete. Not only the hardening period (early strength period) but also the final strength, the quality of the hardened concrete and last but not least durability were well influenced by increased hydration temperatures during and prior to the spraying.

### DETAILED DESCRIPTION OF THE INVENTION

Heat generation during the operation of an air compressor system and partial recovery of this energy source is State of the Art. The application in sprayed concrete processes by warming up liquid admixtures that will be injected at the nozzle to the material's flow has to be recognized as field of the invention.

Sprayed concrete or “shotcrete” is mainly used in underground construction. Its application consists in the conveying of a wet mortar or wet concrete to a nozzle, where a set accelerating admixture and air are added, and it's pneumatically projection at high velocity onto a substrate. Indeed, fast setting and early strength development are needed to allow concrete adhesion on the wall without falls and hence earlier entrance and further excavation are ensured, guarantee security and efficient construction. For this reason, accelerators which ensure rapid development of the mechanical properties are added to the sprayed concrete or sprayed mortar.

It is known that set accelerators influence the hydration process of clinker phases such as C3A and C3S, the consumption of the sulfate carriers and the chemical composition of pore solution at the very beginning stage. The quicker setting caused by adding set accelerators is due to large formation of hydration product like ettringite, resulting in some cases with a poor early strength development which is in the literature correlated to a slow calcium silicate hydrates (C—S—H) formation.

Polycondensates as admixtures are known in the prior art (US 20080108732 A1) to be effective as a superplasticizer in cementitious compositions. US 20080108732 A1 describes polycondensates based on an aromatic or heteroaromatic compound (A) having 5 to 10 C atoms or heteroatoms, having at least one oxyethylene or oxypropylene radical, and an aldehyde (C) selected from the group consisting of formaldehyde, glyoxylic acid and benzaldehyde or mixtures thereof, which result in an improved plasticizing effect of inorganic binder suspensions compared with the conventionally used polycondensates and maintain this effect over a longer period (“slump retention”). In a particular embodiment, these may also be phosphated polycondensates.

Hardening accelerators may contain inorganic and organic components. It is an object of the present invention to provide a method for the application of sprayed concrete by using a 3-way control nozzle as mixing device for ready mix concrete, liquid admixtures and compressed air, characterized in, that the liquid admixtures and/or the conveying air are heated prior and/or to the spraying.

In the application process of sprayed concrete the ready mix concrete will be pumped through hoses to the nozzle where compressed air and admixtures will be injected into the dense material's stream to form an aerosol and mix the admixtures (mainly liquid accelerators) with the wet concrete composition.

With the wet method, a ready mixed concrete from a concrete plant is used, or a prebagged mortar is mixed. The concrete is prepared in the same way as for normal concrete. It is possible to check and control the w/c ratio and thus the quality at any time. The consistency can be adjusted e.g. by means of admixtures.

With the wet-mix method it is easier to produce a uniform quality throughout the spraying process. The ready mix is emptied into a pump and forwarded through the hose by pressure. Today, piston pumps predominate and will continue to do so in the future.

At the nozzle at the end of the hose, compressed air is added to the concrete at a rate of 7-15 m³/min and at a pressure of 7 bar. The air is added to increase the speed of the concrete so that good compaction is achieved as well as adherence to the surface. In addition to the air liquid admixtures such as set accelerators are added at the nozzle.

The admixture normally has a cold or ambient temperature when added at the nozzle to the concrete, also the compressed air (because the air was cooled down before leaving the compressor).

The inventive step is to warm up air and accelerator with the waste heat of the air compressor before entering the nozzle and get into contact with the concrete mix. This has to be done in a heat exchanger next to the compressor.

A specific heat exchange device will exchange the oil heat with the admixture added at the nozzle. Realizing a proper regulation of the admixture temperature during the whole spraying process a 3-way control valve is necessary. In general all heat transfer processes are capable, also where the heat will be transferred to the concrete (at any point of the chain from truck mixer to nozzle).

The warmed-up air and accelerator improve the chemical processes in the sprayed concrete and an improved hardening process is the result.

The compressed air will be generated by a mobile air compressor device and be delivered to the nozzle. During the compression process the air will be heated up and conducted through the device exhaust into the nozzle.

Therefore, in a preferred embodiment of the invention energy and preferably waste energy from the compressor is used for heating up the admixtures and/or the conveying air.

In a preferred embodiment of the invention the method is characterized in, that the oil temperature of the compressor is up to 120° C. and preferably from 80 to 110°.

In a preferred embodiment of the invention the method is characterized in, that the compressor is working at 6 to 8 bar and preferably at a flow volume of 10 m³/min.

In a preferred embodiment of the invention the method is characterized in, that the temperature of the conveying air is adjusted to a temperature between 10° C. to 25° C., by using energy from the compressor.

In a preferred embodiment of the invention the method is according to one of the characterized in, that the heat energy of the compressor and preferably the heat energy of the compressor oil is transferred to the conveying air by using a heat exchanger.

In a preferred embodiment of the invention the method is characterized by the temperature of the liquid concrete from 10° C. to 25° C.

An additional preferred embodiment of the invention is a method of use of the disclosed method according to this invention for the accelerated hardening of sprayed concrete.

In another embodiment of the invention the method for the accelerated hardening of sprayed concrete is characterized by the following steps: providing the ready mix concrete mass; transfer of the ready mix concrete into a pump and forwarding through a hose by using pressure; importing compressed air at a 3-way nozzle at the end of the hose, and adding fluid preheated admixtures to the concrete preferably at a rate of 7-15 m³/min and preferably at a pressure of 7 bar.

Finally another embodiment of the invention is the hardened sprayed concrete produced by a specific method according to this invention.

The following examples illustrate this invention:

### Example 1

Scheme of such a mobile air compressor unit with waste heat recovery during operation.

When air is compressed the total energy will be transferred into thermal heat. The energy distribution is about 80% into the compressor oil, 15% into the compressed air and 5% into the environment (radiation). The energy contained in the compressor oil can be recovered at relatively high temperatures (up to 70° C.) without a negative impact or damage to the compressor device.

When starting the compressor the oil is of low temperature and flows via the oil thermostat (position 9) back into the compressor. When heating up, the oil thermostat opens and the warm oil flows via recuperator (position 27) into the waste heat recovery unit. While the oil loses heat the thermostat (position 26) stays closed and the oil directly flows back into the compressor. When the oil does not exchange the heat the thermostat (position 26) is opening and enables the warm oil to exchange heat via air cooled oil cooling device and then flows back into the compressor.

To allow the up-heated medium (in this case the sprayed concrete accelerator) to regulate its temperature independently to the temperature status of the compressor, a three-way control valve device additionally has to be installed into the circulation system to assure no negative impact to the compressor device.

During a long period of carrying out laboratory concrete spraying tests, field testing and on supporting jobsites the influence of ambient temperature and fresh concrete temperature to the hydration of concrete and sprayed concrete had been observed.

### Example 2

In research literature a wide range of papers is dealing with cement hydration at elevated temperatures, by example:

J. I Escalante-Garcia, J. H. Sharp, “The microstructure and mechanical properties of blended cements hydrated at various temperatures”, Cement and Concrete Research 31 (2001), p. 695-702.

### Laboratory Sprayed Concrete Tests:

TABLE 1
Mix 1 design per 1 m³

| | | |
|---|---|---|
| Cement type CEM I 42.5 N | 450 | kg |
| Sand type A 0-4 mm | 1155 | kg (70%) |
| Sand type B 4-8 mm | 495 | kg (30%) |
| Additive 1: Superplastiziser | 0.6% | bcw |
| Additive 2: Stabilizer | 0.2% | bcw |
| Additive 3: Hardening accelerator | 7.0% | bcw |

| | |
|---|---|
| Water/Cement ratio | 0.45 |

TABLE 2
Strength development during 28 days

| | Mix 1 | Mix 1 |
|---|---|---|
| | (fresh concrete | (fresh concrete |
| | temperature = | temperature = |
| MPa | 20° C.) | 13° C.) |
| SOP 3.3-410071: Strength after 3 min | 0.09 | 0.02 |
| SOP 3.3-410071: Strength after 6 min | 0.10 | 0.10 |
| SOP 3.3-410071: Strength after 15 min | 0.16 | 0.16 |
| SOP 3.3-410071: Strength after 30 min | 0.28 | 0.24 |
| SOP 3.3-410071: Strength after 1 hours | 0.45 | 0.38 |
| SOP 3.3-410071: Strength after 2 hours | 0.62 | 0.55 |
| SOP 3.3-410071: Strength after 4 hours | 2.99 | 1.38 |
| SOP 3.3-410071: Strength after 6 hours | 8.51 | 2.91 |
| SOP 3.3-410071: Strength after 24 | 24.00 | 19.0 |
| hours | | |
| EFNARC, 1999: Strength after 7 days | 41.30 | 30.7 |
| EFNARC, 1999: Strength after 28 days | 49.90 | 39.1 |
| EN 12390: Cube Strength after 1 day | 38.20 | 24.4 |
| EN 12390: Cube Strength after 7 day | 57.20 | 51.3 |
| EN 12390: Cube Strength after 28 day | 69.70 | 63.7 |

### DETAILED DESCRIPTION OF THE DRAWING

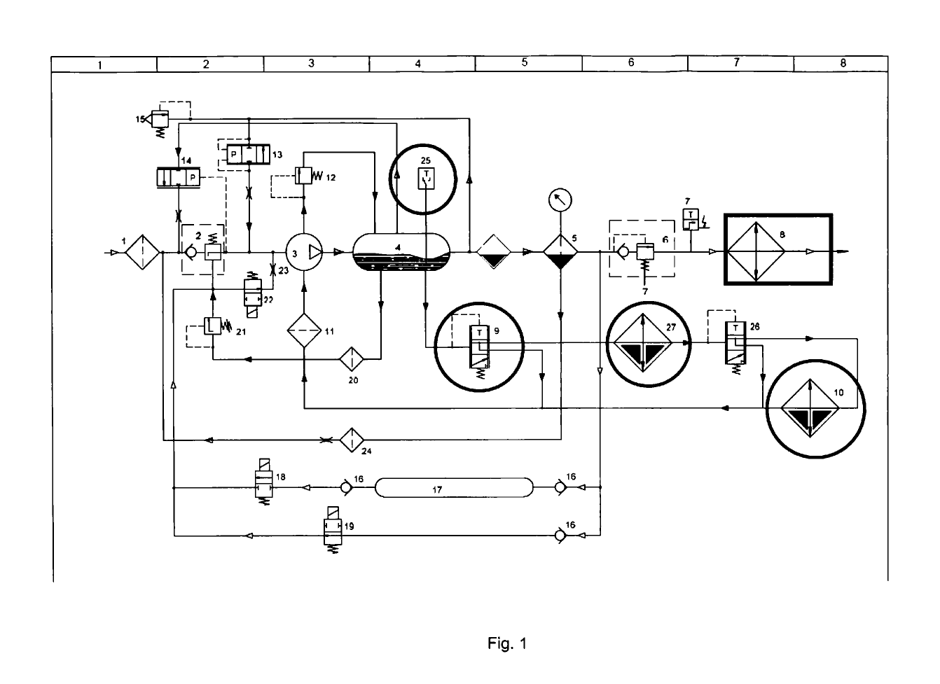

FIG. 1 shows the scheme of such a mobile air compressor unit with waste heat recovery during operation

1. intake filter

2. inlet valve (2 pieces)

3. compressor ladder

4. oil tank

5. oil separator

6. minimum pressure- and back-pressure valve

7. temperature sensor PT 1000

8. forced-air cooler

9. thermostat oil

10. oil cooler

11. oil filter

12. oil pressure protection valve

13. vacuum valve

14. pressure lowering valve

15. safety valve

16. back-pressure valve (3 pieces)

17. compressed air vessel

18. start-auxiliary valve compressed air NC

19. burden idling-control valve NO

20. filter pressure limiting valve 110° C.

21. pressure limiting valve

22. start auxiliary valve exoneration NO

23. regulation nozzle

24. oil return flow nozzle (2 pieces)

25. oil temperature switch

26. thermostat

27. heat exchanger WRG

[symbol] air

[symbol] air/oil

[symbol] oil

1. Method for the application of sprayed concrete by using a 3-way control nozzle as a mixing device for ready mix concrete, liquid admixtures and compressed air, characterized in that the liquid admixtures and/or the conveying air are heated prior and/or during to the spraying.

2. Method according to claim 1, wherein energy and optionally waste energy from the compressor is used for heating.

3. Method according to claim 2, wherein the oil temperature of the compressor is up to 120° C.

4. Method according to claim 2, wherein the compressor is working at 6 to 8 bar.

5. Method according to claim 1, wherein the temperature of the conveying air is adjusted to a temperature between 10° C. to 25° C., by using energy from a compressor.

6. Method according to claim 3, wherein the heat energy of the compressor and optionally the compressor oil is transferred to the conveying air by using a heat exchanger.

7. Method according to claim 1, wherein temperature of the liquid concrete is from 10° C. to 25° C.

8. Method of claim 1, comprising accelerated hardening of sprayed concrete.

9. Method according to claim 8, comprising:
providing the ready mix concrete,
transfer of the ready mix concrete into a pump and forwarding through a hose by using pressure,
importing compressed air at the 3-way nozzle at the end of the hose, and adding fluid preheated admixtures to the concrete.

10. Hardened sprayed concrete produced by a method according to claim 1.

11. Method according to claim 9. wherein the fluid preheated admixtures are added to the concrete at a rate of 7-15 m³/min.

12. Method according to claim 9, wherein the fluid preheated admixtures are added to the concrete at a pressure of 7 bar.

13. Method according to claim 2, wherein the oil temperature of the compressor is from 80 to 110° C.

14. Method according to claim 4, wherein the compressor is working at a flow volume of 10 m³/min.
